(19) United States
(12) Patent Application Publication
(10) Pub. No.: US 2008/0140421 A1
(43) Pub. Date: Jun. 12, 2008

(54) Speaker Tracking-Based Automated Action Method and Apparatus

(75) Inventors: Lawrence J. Marturano, Palatine, IL (US); Scott B. Davis, Walworth, WI (US); Robert A. Zurek, Antioch, IL (US); Andrew J. Aftelak, Palatine, IL (US); George N. Maracas, Phoenix, AZ (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/567,859

(22) Filed: Dec. 7, 2006

(51) Int. Cl. G10L 21/00

(52) U.S. Cl. 704/275

(57) ABSTRACT

At least some speakers engaged in an oral discourse are identified (101) and their oral contributions during that oral discourse tracked (102). At least one visual indicator provided (103) during the oral discourse serves to provide data regarding these tracked contributions (such as, but not limited to, an aggregate length of time that one or more of the participants has spoken). These teachings also provide, however, for automatically taking (104) at least one other action, during the oral discourse, as a function, at least in part, of this tracked oral contribution information.

### TECHNICAL FIELD

This invention relates generally to oral communications.

### BACKGROUND

Oral discourse comprises an ancient human capability. Whether conducted face-to-face or remotely (using, for example, telephony to bridge physically separated participants), oral discourse often comprises an important tool to facilitate mutual understanding and corresponding action and response. In particular, oral discourse often comprises a means whereby one or more individuals provide, receive, or share information regarding a shared topic of interest.

Despite ancient roots, however, successful oral discourse appears to remain as much art or luck as science or defined process. As one example in this regard, so-called small talk can consume valuable scarce time during a limited opportunity to conduct such discourse. As another example, limited time can be misspent when oral contributions are made by participants who should probably be listening more and speaking less. As yet another example in this regard, the opportunities inherent to oral discourse can be lost when a participant who should speak fails, for whatever reason, to speak.

By one prior art approach, the individual participants of an oral discourse are identified (using, for example, speaker recognition techniques) and their respective contributions tracked as a function of time. A corresponding indication of such information is then provided to one or more of the discourse participants. Thus, one may know, for example, that a first speaker has spoken, so far, 11 minutes while a second speaker has spoken, so far, 28 minutes.

Though potentially helpful in some application settings, such an approach still tends to leave many opportunities for problems to arise. Such an approach, for example, relies heavily upon how the information recipient interprets the data. Using the example above, is it good, or bad, that the second speaker has spoken more than twice as long as the first speaker? Absent context, the data is ambiguous. This remains true even when the data appears completely lopsided. For example, if a given instance of oral discourse involves five speakers, with four have uttered nothing while the fifth has spoken for 60 minutes, is this good or bad? Again, the answer depends upon context; there is nothing inherently right or wrong about such a circumstance.

As a result, such an approach tends to provide more of an illusion of benefit rather than actual benefit in many application settings. The participants may, or may not, have any real sense or understanding of when a given oral discourse is going, or has gone, well based solely upon such information.

### BRIEF DESCRIPTION OF THE DRAWINGS

The above needs are at least partially met through provision of the a speaker tracking-based automated action method and apparatus described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, at least some speakers engaged in an oral discourse are identified and their oral contributions during that oral discourse tracked. At least one visual indicator provided during the oral discourse serves to provide data regarding these tracked contributions (such as, but not limited to, an aggregate length of time that one or more of the participants has spoken). These teachings also provide, however, for automatically taking at least one other action, during the oral discourse, as a function, at least in part, of this tracked oral contribution information.

This other action can comprise, or can itself be based upon, a determination regarding a relative level of subject matter expertise as pertains to one or more of the identified speakers. Such information, in turn, can be provided in conjunction with the aforementioned visual indicators to thereby provide, in a sense, a substantive weighting to the information regarding time spent speaking by each participant. So configured, a large quantity of time spent speaking by a subject matter expert can be interpreted as a successfully conducted oral discourse rather than the converse.

This other action can also comprise, in lieu of an expert determination as noted above or in combination therewith, the use of one or more automated oral prompts that are offered during the oral discourse. Such oral prompts can be based, for example, upon a calculation that a participating subject matter expert has not yet spoken at sufficient length. Such oral prompts could also be based, if desired, upon a desired to achieve or at least encourage a certain parity amongst the speakers with respect to their speaking time.

So configured, the raw data regarding speaking time for various speakers can be viewed with the benefit of context and/or can serve to drive an automated facilitation process that serves to urge the participants towards behavior that will likely lead to a more successful oral discourse. Those skilled in the art will appreciate that these teachings can be practiced in an economically feasible manner and in as transparent, or overt, a manner as may be wished. These teachings are also readily scalable and can accommodate a relatively large number of speakers if desired.

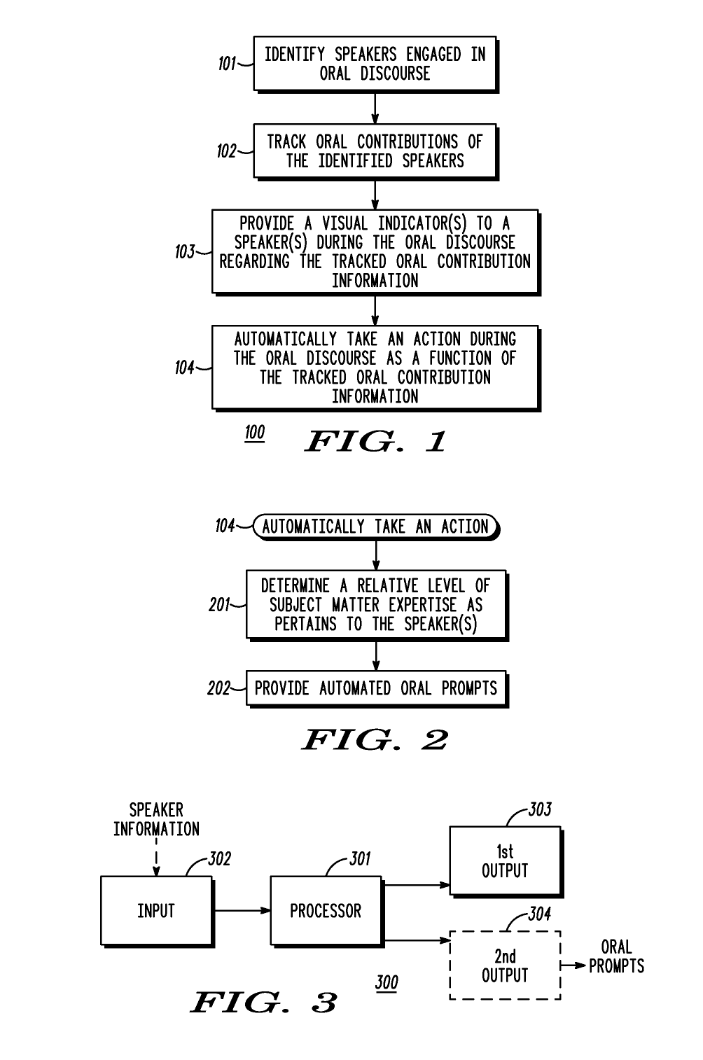

These and other benefits may become clearer upon making a thorough review and study of the following detailed description. Referring now to the drawings, and in particular to FIG. 1, an illustrative process 100 as comports with these teachings provides for identifying 101 at least some speakers who are engaged in an oral discourse to thereby provide corresponding identified speakers. This may comprise all of the speakers who are (or who may be) engaged in the oral discourse or, if desired, fewer than all of the speakers. For example, when there are a large number of technically potential speakers but only a few speakers of significant import (as may exist, for example, when an audience of 100 people is listening to a panel discussion involving five primary speakers), it may be desirable or useful to only identify the primary speakers in the described manner.

There are various ways by which such identification can be carried out. Automatic speaker identification techniques and platforms are known in the art and can be applied in this setting. As another approach, when it is possible to correlate the speakers with corresponding independent speaking inputs (as may be the case when dealing with several incoming voice streams carried by discrete phone lines, microphone feeds, or the like), each of those inputs can serve as a way of discerning when a given speaker is offering an oral contribution.

The nature of the identification itself can vary with the needs and/or opportunities as correspond to a given application setting. By one approach, each speaker can simply be denoted with an assigned or self-selected alias or the like. For example, when there are three speakers to consider, they can simply be denoted as SPEAKER 1, SPEAKER 2, and SPEAKER 3 if desired. By another approach, each speaker can be denoted with their actual name. Such a name might be gleaned in various ways before or during the oral discourse. By one approach, for example, each speaker can be asked to provide their identifying moniker prior to the initiation of the oral discourse. As another example, each speaker might be identifiable by automatically correlating their speech sample content with a database of previously obtained information in this regard. By yet another approach, each speaker can be denoted through use of some indicator that corresponds to their status, profession, expertise, or the like. For example, and again assuming a group of three speakers, VICE PRESIDENT, BUSINESS MANAGER, and ENGINEERING MANAGER might serve as appropriate identifiers in a given illustrative application setting.

Those skilled in the art will understand that this step can be carried out for speakers who are conversing in a long distance oral discourse and/or for speakers who are speaking in a face-to-face setting. For example, this step (and this process 100) can be applied during a conference call, during a videoconference, or during a group in-person meeting as desired.

Having established the identity of the speakers, this process 100 then provides for tracking 102 the oral contributions of the identified speakers with respect to the oral discourse. This, in turn, provides corresponding tracked oral contribution information. The particular tracked characteristic tracked in this manner can vary with the needs and/or opportunities of a given application setting. By one approach, this can comprise developing information regarding how long each of the identified speakers has spoken during the oral discourse. Such information can be tracked, for example, with a desired degree of resolution. For example, such durations can be tracked to the closest quarter hour, minute, second, or the like.

Those skilled in the art will appreciate that other possibilities exist in this regard. For example, when employing speech recognition capabilities, the substantive content of such oral contributions can be considered as well. This can range from rather simple considerations (such as a simple count that reflects how many epithets have been offered by each speaker during the oral discourse) to more complicated considerations (such as whether particular subjects have been discussed or the like). Relative volume measurements can be used to track which speakers appear to exhibit greater excitement, agitation, bluster, or the like. Voice-stress detectors can be used to provide information regarding which speakers are exhibiting stress, or a greater amount of relative stress, during their offerings. These and other considerations (as may be presently known or as may be developed hereafter) can be used, alone or in combination with one another, to meet the needs and/or requirements of a given application setting.

This process 100 then provides 103 at least one visual indicator to at least one of the speakers during the oral discourse regarding the tracked oral contribution information. This can comprise, for example, providing a visual indication regarding a duration of time that a given speaker has spoken. The specific nature of the visual indicator can vary with the capabilities or limitations of the viewer's platform as will be well understood by those skilled in the art. Examples of such a visual indicator would include, but are not limited to, a numeric value (representing, for example, the duration of the speaker's present uninterrupted offering, an aggregated running value of that speaker's offerings during the present oral discourse, or the like), a graphic representation (using, for example, a gauge of digital or analog appearance), or the like.

By one approach, the visual indicator can simply represent a present running value of the tracked oral contribution. By another approach, the visual indicator can comprise a relative value indicator. To illustrate, a maximum and/or minimum desired range of speaking time can be shown for a given speaker, and the actual speaking time relative to that desired range can be provided without necessarily also showing the actual time that has been consumed by this particular speaker. As another illustration in this regard, a representation of a particular speaker's speaking time relative to a total amount of time that has been scheduled for the oral discourse can be provided. As yet another illustration in this regard, a representation of each speaker's speaking time can be shown in comparison to a total amount of speaking time that is available for all speakers (using, for example, a pie chart form factor where colors or other indicators could serve to differentiate the speakers from one another).

This process 100 also provides for automatically taking 104 at least one other action, during the oral discourse, as a function, at least in part, of the tracked oral contribution information. The precise nature of this action can vary with the needs and/or opportunities as may characterize a given setting.

Referring now to FIG. 2, by one approach, this action can optionally comprise determining 201 a relative level of subject matter expertise as pertains to at least one or even all of the identified speakers. In particular, this can comprise determining a level of subject matter expertise as pertains to a planned subject matter topic of the oral discourse. Such a step can be accomplished using any of a variety of approaches.

For example, this can comprise accessing a previously established profile for the identified speakers. This profile may be maintained and/or accessed locally (for example, this information can comprise a part of the platform that is otherwise effectuating the steps set forth herein) or can be maintained and/or accessed remotely (as when the information is provided via a corresponding server or other remotely located resource including, for example, on-line biography information as may be available for some or all of the speakers). This information can comprise long-standing information or may, if desired, be of only recent establishment (as when the profile is populated with data gleaned from each speaker regarding themselves via an interview or application process that immediately precedes the oral discourse).

As another example, this step can comprise using information provided by at least one of the speakers regarding such status for at least one other of the speakers. Such information can be provided prior to the oral discourse and/or during the course of the oral discourse. This peer-based approach to recognizing subject matter expertise may be particularly useful in some application settings as it leverages and relies upon the interests and perceptions of the speakers themselves.

So configured, such subject matter expertise information can be included with the aforementioned tracking information, if desired. That is, a given speaker's relative expertise with respect to a schedule topic of discussion can be displayed in conjunction with an indication of their actual or relative contributions. This, in turn, can be used by various of the speakers to assess whether a particular speaker is making too few, or too many, offerings during the oral discourse. Such information could also be used in a more initially proactive manner if desired. For example, when displaying a speaker's relative degree of contribution in comparison to an expected or permitted range, that range can itself be varied as a function, at least in part, of this information regarding subject matter expertise.

To illustrate, an expert participant might be scheduled to offer up to 30 minutes of oral contributions during a one hour discussion while a non-expert might be relegated to only 10 minutes. In such a case, the expert could be shown, via a visual indicator, to have only consumed half of their allotted speaking time upon having spoken for 15 minutes while the non-expert will be shown to have consumed half of their allotted speaking time upon having spoken for only five minutes.

The aforementioned action can also optionally comprise, alone or in combination with the aforementioned use of subject matter expertise information, providing 202 automated oral prompts during the oral discourse as a function, at least in part, of the tracked oral contribution information. There are various ways by which such oral prompts can be realized. By one approach, pre-recorded prompts can be provided and used as appropriate. By another approach, text-to-speech synthesizers can be used in a similar manner for these purposes.

By one approach, the automated oral prompts serve as a virtual discussion facilitator. Accordingly, the oral prompts themselves can comprise statements that are designed and intended to, for example, encourage further oral contributions from a given one of the identified speakers who has contributed less than a given quantity of oral contributions to the oral discourse or to discourage further oral contributions from a given one of the identified speakers who has contributed more than a given quantity of oral contributions to the oral discourse. This can include, if desired, the use of the names (or aliases, titles, or the like) of the speakers. Accordingly, these oral prompts can comprise, by one approach, suggestions that prompt reduced, or increased, oral contributions from momentarily identified speakers.

As a very simple illustration in this regard, when an oral discourse that is scheduled to last for one hour has reached the 45 minute point, these teachings may have produced tracked information as follows:

Bob (a subject matter expert)—11 minutes

Gopika (a subject matter non-expert)—28 minutes

Xi (a subject matter non-expert/business manager)—0 minutes

Admar (a subject matter non-expert)—6 minutes

In this example, the automated facilitation capability may now determine that Gopika has spoken for too great a time while Xi has made insufficient offerings. By one approach, an oral prompt could now be automatically provided along the lines of, “Excuse me, but time is beginning to run a bit short. Xi, do you have any thoughts to share?” If Gopika were to immediately begin talking, if desired, these teachings would accommodate responding with a stronger automated oral prompt such as, “Pardon me, Gopika. I'm sorry to interrupt, but you have spoken at length and it is important that others have an opportunity to speak as well.”

If desired, such an automated process could be provided with speech recognition capabilities to facilitate at least limited two-way interchanges. As one simple example, at least one participant of such a process could be accorded the authority to override the process's objections or facilitation attempts to permit a non-standard course of conduct to continue.

As another simple example, and referring again to the illustrative tracking data provided above, such an automated facilitation capability may now determine that Bob, a subject matter expert, has not made a sufficient contribution. This may be viewed as comprising a more important concern than Xi's lack of contribution. Accordingly, in this case, an oral prompt such as, “Excuse me, but time is beginning to run short. Bob, you're our resident expert—are there some other points that ought to be considered before we end this discussion?” could be automatically offered.

Such an automated facilitation capability could be used in other respects as well, of course. For example, upon discerning that little discourse was occurring, such a facility could select a particular participant who had made the least contribution so far and provide an oral prompt such as, “Sun Wu, do you have any thoughts on this matter?”

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

This illustrative platform 300, which might comprise, for example, a long distance communications platform such as a telephone, speakerphone, or a corresponding accoutrement thereto, can comprise a processor 301 that is configured and arranged to effectuate selected teachings as are presented herein. Those skilled in the art will recognize and understand that numerous alternative approaches exist to facilitate such a result. For example, such a processor 301 can comprise a partially or fully programmable platform that is readily programmed to achieve the desired configuration and operability.

This processor 301 operably couples to an input 302 that is configured and arranged to receive the aforementioned information regarding the speakers who are engaged in an oral discourse. This can comprise already-processed information in this regard or can comprise, if desired, the raw audio content itself. In the latter case, the processor 301 can be supplemented with speaker recognition capability to facilitate accomplishing the aforementioned identification activities.

This processor 301 also operably couples to at least a first output 303 that provides the aforementioned visual indications regarding oral contributions as are offered by these speakers. Optionally, this processor 301 can also operably couple to a second output 304 that serves, for example, to provide the aforementioned oral prompts.

So configured, such an apparatus 300 can readily serve to identify at least some speakers who are engaged in an oral discourse and to track their respective oral contributions with respect to that oral discourse. Corresponding visual indications regarding that tracked oral contribution information can be provided to one or more of the participants (or to other parties as may be desired) and one or more other actions can be automatically taken during the oral discourse as a function, at least in part, of that tracked oral contribution information as described above. This can include obtaining and using information that characterizes the relative subject matter expertise of the speakers and/or using automated oral prompts to facilitate the oral discourse in various ways.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, these teachings can greatly improve the relative value and substance of any of a wide variety of oral discourses including discussions amongst locally situated as well as remotely situated participants. These benefits are achievable at reasonable cost and in a highly scalable manner. Great flexibility also exists with respect to the precise manner by which these teachings are applied, thereby permitting an optimized solution to be fashioned on a case-by-case basis. These teachings are also sufficiently flexible to likely well accommodate future developments. For example, to the extent that a virtual speaker (such as an artificially intelligent platform having a speech output capability) becomes available, such a virtual speaker could easily and readily be processed and treated the same as any other speaker during a given oral discourse.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, the tracked information can be provided, subsequent to the oral discourse, to some or all of the participants and/or to other interested parties as a kind of report card regarding the successful or unsuccessful conduct of that session.

We claim:

1. A method comprising:
identifying at least some speakers engaged in an oral discourse to provide identified speakers;
tracking oral contributions of the identified speakers with respect to the oral discourse to provide tracked oral contribution information;
providing at least one visual indicator to at least one of the speakers during the oral discourse regarding the tracked oral contribution information;
automatically taking at least one other action, during the oral discourse, as a function, at least in part, of the tracked oral contribution information.

2. The method of claim 1 wherein tracking oral contributions of the identified speakers with respect to the oral discourse to provide tracked oral contribution information comprises tracking durations of time for the oral contributions of the identified speakers with respect to the oral discourse to provide tracked oral contribution information comprising, at least in part, information regarding how long each of the identified speakers has spoken during the oral discourse.

3. The method of claim 2 wherein automatically taking at least one other action, during the oral discourse, as a function, at least in part, of the tracked oral contribution information comprises determining a relative level of subject matter expertise as pertains to at least one of the identified speakers.

4. The method of claim 3 wherein determining a relative level of subject matter expertise as pertains to at least one of the identified speakers comprises at least one of:
accessing a previously established profile for the at least one of the identified speakers;
using information provided by at least one of the speakers regarding such status for at least one other of the speakers;
using information provided in connection with the oral discourse by the at least one of the identified speakers regarding themselves.

5. The method of claim 3 wherein determining a relative level of subject matter expertise as pertains to at least one of the identified speakers comprises, at least in part, determining a relative level of subject matter expertise as pertains to at least one of the identified speakers with respect to a subject matter of the oral discourse.

6. The method of claim 3 wherein determining a relative level of subject matter expertise as pertains to at least one of the identified speakers comprises determining a relative level of subject matter expertise as pertains to all of the identified speakers.

7. The method of claim 3 wherein identifying at least some speakers engaged in an oral discourse to provide identified speakers comprises identifying at least some speakers engaged in a long distance oral discourse.

8. The method of claim 3 wherein providing at least one visual indicator to at least one of the speakers during the oral discourse regarding the tracked oral contribution information comprises providing a visual indication regarding a duration of time that a given subject matter expert has spoken relative to other of the speakers during the oral discourse.

9. The method of claim 3 wherein automatically taking at least one other action, during the oral discourse, as a function, at least in part, of the tracked oral contribution information further comprises providing automated oral prompts during the oral discourse as a function of the tracked oral contribution information to facilitate oral contributions by an identified speaker having subject matter expertise.

10. The method of claim 2 wherein automatically taking at least one other action, during the oral discourse, as a function, at least in part, of the tracked oral contribution information comprises providing automated oral prompts during the oral discourse as a function, at least in part, of the tracked oral contribution information.

11. The method of claim 10 wherein providing automated oral prompts during the oral discourse as a function, at least in part, of the tracked oral contribution information comprises providing an automated oral prompt that is configured and arranged to at least partially discourage further oral contributions from a given one of the identified speakers who has contributed more than a given quantity of oral contributions to the oral discourse.

12. The method of claim 10 wherein providing automated oral prompts during the oral discourse as a function, at least in part, of the tracked oral contribution information comprises providing an automated oral prompt that is configured and arranged to at least partially encourage further oral contributions from a given one of the identified speakers who has contributed less than a given quantity of oral contributions to the oral discourse.

13. The method of claim 10 wherein providing automated oral prompts comprises providing an oral prompt that momentarily identifies at least one of the speakers to provide a momentarily identified speaker and that directs a prompt to that momentarily identified speaker regarding further oral contributions to the oral discourse.

14. The method of claim 13 wherein the prompt comprises at least one of:
a suggestion that prompts reduced oral contributions from the momentarily identified speaker;
a suggestion that prompts increased oral contributions from the momentarily identified speaker.

15. The method of claim 10 wherein providing automated oral prompts during the oral discourse as a function, at least in part, of the tracked oral contribution information comprises providing automated oral prompts during the oral discourse as a function, at least in part, of the tracked oral contribution information and at least one perception regarding subject matter expertise of at least one of the identified speakers.

16. An apparatus comprising:
an input configured and arranged to receive information regarding speakers engaged in an oral discourse;
a first output configured and arranged to provide visual indications regarding oral contributions offered by the speakers during the oral discourse;
a processor operably coupled to the input and the first output and being configured and arranged to:
identify at least some speakers engaged in the oral discourse to provide identified speakers;
track oral contributions of the identified speakers with respect to the oral discourse to provide tracked oral contribution information;
provide the visual indications via the first output as a function, at least in part, of the tracked oral contribution information;
automatically take at least one other action, during the oral discourse, as a function, at least in part, of the tracked oral contribution information.

17. The apparatus of claim 16 wherein the at least one other action comprises determining a relative level of subject matter expertise as pertains to at least one of the identified speakers.

18. The apparatus of claim 17 wherein the visual indications comprise at least one visual indicator regarding a duration of time that a given subject matter expert has spoken relative to other of the speakers during the oral discourse.

19. The apparatus of claim 16 wherein the at least one other action comprises providing automated oral prompts during the oral discourse as a function, at least in part, of the tracked oral contribution information to at least attempt to influence a level of participation of at least one of the speakers.

20. The apparatus of claim 16 wherein the apparatus comprises a long distance communications platform.
